(19) United States
(12) Patent Application Publication
(10) Pub. No.: US 2011/0015792 A1
(43) Pub. Date: Jan. 20, 2011

(54) METHOD FOR IDENTIFICATION OF PNEUMATIC DRIVES

(75) Inventors: Andreas WAHLMANN, Meerbeck (DE); Heiko Kresse, Obernkirchen (DE); Wolfgang Scholz, Minden (DE)

Correspondence Address: BUCHANAN, INGERSOLL & ROONEY PC, POST OFFICE BOX 1404, ALEXANDRIA, VA, 22313-1404, US

(73) Assignee: ABB Technology AG, Zurich (CH)

(21) Appl. No.: 12/835,932

(22) Filed: Jul. 14, 2010

(30) Foreign Application Priority Data
Jul. 15, 2009 (DE) 10 2009 033 214.6

(51) Int. Cl. G05D 16/20; G05D 7/06

(52) U.S. Cl. 700/282

(57) ABSTRACT

The disclosure relates to a system and method for identification of pneumatic drives. The pneumatic actuating drive is controlled by an electro-pneumatic position regulator, which is equipped with a microcontroller, at least one electro-pneumatic transducer for controlling the pressure-medium flow to and from the drive, and a communication interface. After the position regulator has been started up with an initial setting, a nominal value profile and an actual value profile can be analyzed during operation and, if a control error exceeds a predeterminable minimum value, the manipulated variable from the position regulator can be temporarily replaced by a test signal during which operating parameters of the controlled system are recorded from which current regulator parameters are determined.

### RELATED APPLICATION

This application claims priority under 35 U.S.C. §119 to German Patent Application No. 10 2009 033 214.6 filed in Germany on Jul. 15, 2009, the entire content of which is hereby incorporated by reference in its entirety.

### FIELD

A system and a method are disclosed for identification of pneumatic drives, such as those used for automation in process installations.

### BACKGROUND INFORMATION

Exemplary pneumatic drives include electro-pneumatic position regulators which control the position of pneumatically actuated actuating or control valves as a function of a nominal value preset. The position regulator can have a communication interface designed for connection of a digital fieldbus or of an analog 0/4.20 mA conductor loop. For carrying out the control, a control algorithm can be implemented in software on a microcontroller.

There is a demand for position regulators to control a wide range of pneumatic drives with different control characteristics. In particular but not exclusively, these include single-acting and double-acting drives, a wide range of drive volumes and actuating speeds, various types of friction and various non-linear effects in the controlled system. These characteristics are unknown before the position regulator is started up on the drive. The regulator parameters therefore cannot be determined by calculation before start-up. For this reason, position regulators have a self-adjustment process which, like the regulator, can be implemented in software on a microcontroller. This process is carried out during start-up, in order to find regulator parameters which are as optimum as possible for the drive being used.

In an exemplary self-adjustment processes, signals can pass as a manipulated variable to the system to be controlled or as a nominal value to the closed control loop with a basic setting of the regulator, and the reaction measured. Various signal forms, such as step functions or ramps for example, are used as input signals. During self-adjustment the regulator is not in operation. The position of the drive to be regulated then does not follow the externally preset nominal value. The data obtained from the system reaction is used to calculate the regulator parameters.

These self-adjustment processes can be carried out only when the regulator is out of operation. Therefore, at least the relevant installation part is taken out of operation for the pneumatic control drive to be started up. If this is impossible, for example in the event of replacement, the start-up is carried out outside the process installation. Furthermore during the first starting up of installations in which a large number of pneumatic control drives are used, this can result in a relatively long time period solely for self-adjustment of all the pneumatic drives.

Furthermore, during practical use, it has been found that those characteristics of pneumatic drives which are relevant for control purposes can vary over the life of the equipment. The regulator parameters are therefore readjusted in order to maintain good control characteristics in the long term. The regulator parameters are readjusted by adaptation methods which are specifically matched to the regulators being used. The data for adaptation is determined during control operation.

The known adaptation methods are based on rules different to those for the self-adjustment processes. They are fundamentally different since the data used for adaptation is determined during control operation. In consequence, the determined parameters of self-adjustment and adaptation differ, and may lead to different control behaviors, extending to a tendency to oscillate and instabilities.

### SUMMARY

A method is disclosed for identification of a regulator parameter of a pneumatic actuating drive which is controlled by an electro-pneumatic position regulator, and which is equipped with a microcontroller for running a predetermined control algorithm, wherein at least one electro-pneumatic transducer is provided for controlling a pressure-medium flow to and from the drive, and wherein a communication interface is provided for reception of nominal value presets of a nominal value profile, the control algorithm being a computer implemented program for determining a regulator parameter from a recorded operating parameter of the position regulator, and comprising: setting the regulator parameter of the position regulator to a basic setting to start the position regulator; and repeatedly analyzing, the nominal value profile and an actual value profile during operation of the position regulator such that when a control error exceeds a specified minimum value, a manipulated variable from the position regulator is temporarily replaced by a test signal having a predetermined time profile, during which operating parameters of a controlled system are recorded to determine a current regulator parameter.

An electro-pneumatic position regulator is disclosed for controlling a pneumatic actuating drive, the electro-pneumatic position regulator comprising: a communication interface for receiving nominal value presets of a nominal value profile; and a microcontroller containing a computer implemented program for determining a regulator parameter from an operating parameter of the position regulator by setting the regulator parameter to an initial value, and by repeatedly analyzing the nominal value profile and an actual value profile during operation of the position regulator such that when a control error exceeds a specified minimum value, a manipulated variable from the position regulator is temporarily replaced by a test signal having a predetermined time profile, during which operating parameters of a controlled system are recorded to determine a current regulator parameters.

### BRIEF DESCRIPTION OF DRAWINGS

Exemplary embodiments will be explained in more detail in the following text with reference to the drawings, wherein:

FIG. 1 shows an outline illustration of an exemplary electro-pneumatically controlled valve arrangement; and

FIG. 2 shows an exemplary flowchart in order to illustrate exemplary method steps disclosed herein.

### DETAILED DESCRIPTION

A method is disclosed for identification of pneumatic drives, which method is suitable for determining regulator parameters during control operation and independently of the operating state.

The disclosure relates to a pneumatic drive which can be controlled by an electro-pneumatic position regulator, which can be equipped with a microcontroller for running a predetermined control algorithm, having at least one electro-pneumatic transducer for controlling the pressure-medium flow to and from the drive, and having a communication interface for reception of nominal value presets. An exemplary control algorithm includes a method for determination of regulator parameters from recorded operating parameters of the position regulator.

According to exemplary embodiments of the disclosure, the regulator parameters of the position regulator can be initially set to a basic setting. This basic setting can be determined directly in the manufacturer's premises. The position regulator is fitted to the drive and is started up using this basic setting. Alternatively, the basic setting can also be based on an automatic start-up procedure or manual setting of the regulator parameters.

The nominal value profile and the actual value profile can, for example, be analyzed during operation. As soon as the control error exceeds a predeterminable minimum value, the manipulated variable from the regulator is temporarily replaced by a test signal with a predetermined time profile. Thus, the magnitude and mathematical sign of the test signal follow the manipulated variable in such a way that the control error is reduced. Operating parameters of the controlled system are recorded while the test signal is present. The current regulator parameters are determined by means of the implemented method from these operating parameters. Operation of the regulator then continues with the determined regulator parameters. The method steps can be processed repeatedly during operation.

After the end of the test signal, the manipulated variable can be once again passed from the regulator to the controlled system. The control error is monitored while the test signal is present. If the control error unexpectedly increases, the adaptation process is terminated immediately, and the manipulated variable from the regulator is passed to the controlled system again.

In exemplary embodiments, both the identification of the drive and its regulator parameters on start-up, and the continuous adaptation to ageing-dependent changes in the drive as well as the determination of the exact parameters during control operation, can be achieved by a single method. This can successfully avoid competing settings resulting in control loop instabilities.

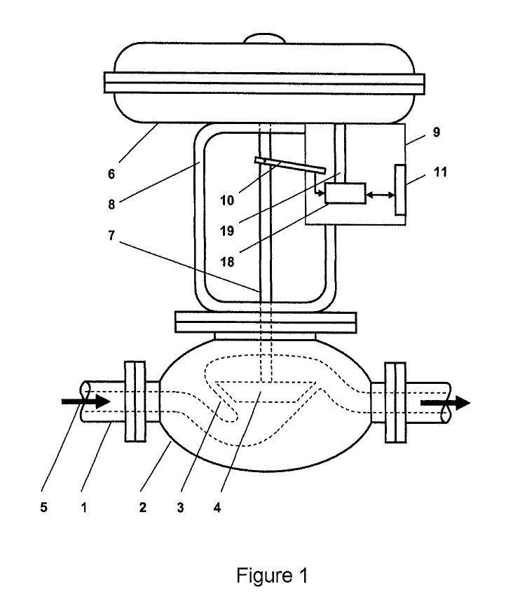

FIG. 1 shows an exemplary embodiment of a pipeline 1, indicated in fragmentary form, of a process installation, which is not illustrated in any more detail, and a process valve 2 installed as an actuating element. In its interior, the process valve 2 has a closing body 4 which interacts with a valve seat 3 in order to control the amount of processed medium 5 passing through. The closing body 4 is operated linearly by a pneumatic actuating drive 6 via a lifting mechanism 7. The actuating drive 6 is connected to the process valve 2 via a yoke 8. A digital position regulator 9 is fitted to the yoke 8. The lifting movement of the lifting mechanism 7 is signaled to the position regulator 9 via a position sensor 10. The detected lifting movement is compared in control electronics 18 (e.g., a microcontroller) with the nominal value supplied via a communication interface 11, and the actuating drive 6 is operated as a function of the determined control error. The control electronics 18 of the position regulator 9 operates an I/P converter in order to convert an electrical control error to an adequate control pressure. The I/P converter of the position regulator 9 is connected to the actuating drive 6 via a pressure-medium supply 19.

The position sensor 10 is connected in the position regulator 9 to the axis of rotation of a potentiometer, and has an eye in which a driver on the lifting mechanism 7 engages.

The control electronics 18 of the position regulator 9 can be, or can include a microcontroller which is suitable for running a predetermined control algorithm. This control algorithm can comprise a method for determination of regulator parameters from recorded operating parameters of the position regulator 9.

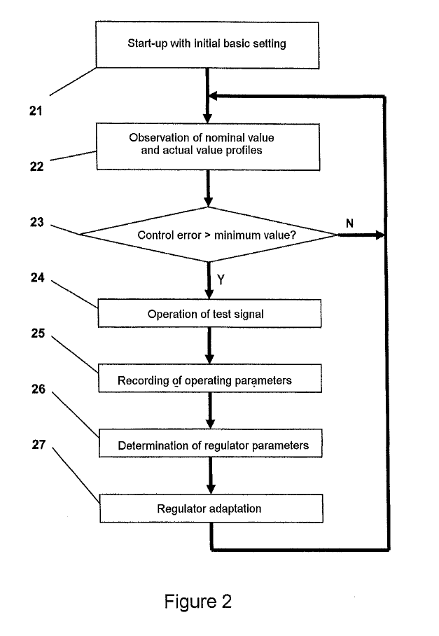

FIG. 2 shows an exemplary flowchart in order to illustrate method steps according to an exemplary embodiment. First of all, the regulator parameters of the position regulator 9 are initially set to a basic setting during start-up (e.g., initialized to any desired value), step 21. The position regulator 9 is fitted to the actuating drive 6, and is started up, using this basic setting.

During operation, as shown in FIG. 2 the steps 22 to 27 can be carried out repeatedly. The profile of the nominal value supplied via the communication interface 11 and the profile of the actual value position of the position sensor 10 are observed and analyzed continuously in step 22. As soon as the control error exceeds a predeterminable minimum value, step 23, the manipulated variable from the control electronics 18 of the position regulator 9 is temporarily replaced in step 24 by a test signal with a predetermined time profile. In this case, the magnitude and mathematical sign of the test signal follow the manipulated variable so as to reduce the control error. Position actual values of the actuating drive 6 are recorded while the test signal is present. The speed and the acceleration of the activating drive 6 are determined in detail from the predetermined time profile of the test signal and the recorded position actual values, step 25. The implemented method uses these operating parameters to determine the current regulator parameters, step 26. Operation of the position regulator 9 from then on continues with the new regulator parameters, step 27. For this purpose, after the end of the test signal, the manipulated variable from the control electronics 18 of the position regulator 9 is once again passed to the actuating drive 6.

In an exemplary embodiment, the control error can be monitored while the test signal is present. If the control error unexpectedly increases, the adaptation process is terminated immediately, and the manipulated variable from the control electronics 18 of the position regulator 9 is passed to the actuating drive 6.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Pipeline
2 Process valve
3 Valve seat
4 Closing body
5 Process medium
6 Actuating drive
7 Valve rod
8 Yoke
9 Position regulator
10 Position sensor
11 Communication interface
18 Control electronics
19 Pressure-medium supply

21.27 Steps

What is claimed is:

1. A method for identification of a regulatory parameter of a pneumatic actuating drive which is controlled by an electro-pneumatic position regulator, and which is equipped with a microcontroller for running a predetermined control algorithm, wherein at least one electro-pneumatic transducer is provided for controlling a pressure-medium flow to and from the drive, and wherein a communication interface is provided for reception of nominal value presets of a nominal value profile, the control algorithm being a computer implemented program for determining a regulator parameter from a recorded operating parameter of the position regulator, and comprising:
setting the regulator parameter of the position regulator to a basic setting to start the position regulator; and
repeatedly analyzing the nominal value profile and an actual value profile during operation of the position regulator such that when a control error exceeds a specified minimum value, a manipulated variable from the position regulator is temporarily replaced by a test signal having a predetermined time profile, during which operating parameters of a controlled system are recorded to determine a current regulator parameter.

2. The method as claimed in claim 1, comprising:
passing the manipulated variable from the position regulator to the controlled system after the test signal ends.

3. The method as claimed in claim 2, comprising:
monitoring the control error while the test signal is present.

4. The method as claimed in claim 3, comprising:
terminating an adaptation process and passing the manipulated variable from the position regulator to the controlled system when the control error increases while the test signal is applied.

5. The method as claimed in claim 1, comprising:
determining speed and acceleration of the actuating drive from the recorded operating parameters.

6. The method as claimed in claim 2, comprising:
determining the current regulator parameter from speed and acceleration of the actuating drive.

7. An electro-pneumatic position regulator for controlling a pneumatic actuating drive, the electro-pneumatic position regulator comprising:
a communication interface for receiving nominal value presets of a nominal value profile; and
a microcontroller containing a computer implemented program for determining a regulator parameter from an operating parameter of the position regulator by setting the regulator parameter to an initial value, and by repeatedly analyzing the nominal value profile and an actual value profile during operation of the position regulator such that when a control error exceeds a specified minimum value, a manipulated variable from the position regulator is temporarily replaced by a test signal having a predetermined time profile, during which operating parameters of a controlled system are recorded to determine a current regulator parameter.

8. The electro-pneumatic position regulator as claimed in claim 7, wherein the computer-implemented program comprises:
passing the manipulated variable from the position regulator to the controlled system after the test signal ends.

9. The electro-pneumatic position regulator as claimed in claim 7, wherein the computer-implemented program comprises:
monitoring the control error while the test signal is present.

10. The electro-pneumatic position regulator as claimed in claim 7, wherein the computer-implemented program comprises:
terminating an adaptation process and passing the manipulated variable from the position regulator to the controlled system when the control error increases while the test signal is applied.

11. The electro-pneumatic position regulator as claimed in claim 7, wherein the computer-implemented program comprises:
determining speed and acceleration of the actuating drive from the recorded operating parameters.

12. The electro-pneumatic position regulator as claimed in claim 7, wherein the computer-implemented program comprises:
determining the current regulator parameters from speed and acceleration of the actuating drive.
